(19) United States
(12) Patent Application Publication
(10) Pub. No.: US 2012/0069114 A1
(43) Pub. Date: Mar. 22, 2012

(54) IMAGE FORMING APPARATUS AND IMAGE FORMING METHOD

(75) Inventors: Yoshiaki Kaneko, Shizuoka-ken (JP); Hirofumi Kondo, Kanagawa-ken (JP); Satoshi Kaiho, Kanagawa-ken (JP); Kazuhiro Hara, Shizuoka-ken (JP); Masahiro Doi, Shizuoka-ken (JP); Yasushi Kuribayashi, Shizuoka-ken (JP); Nobuaki Takahashi, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,756

(22) Filed: Sep. 14, 2011

Related U.S. Application Data
(60) Provisional application No. 61/384,056, filed on Sep. 17, 2010.

(51) Int. Cl. B41J 2/01; B65H 3/14; B65H 5/34; B65H 7/12; B65H 5/26; B65H 3/18; B65H 3/52

(52) U.S. Cl. 347/104; 271/18.1; 271/98; 271/125; 271/110; 271/186; 271/270; 271/265.04

(57) ABSTRACT

According to one embodiment, an image forming apparatus includes a retaining roller, a nipping device, a retaining device, an image forming head, and a controller. The retaining roller retains a recording medium and rotates. The nipping device is capable of operating to open and close and holds the recording medium between the nipping device and the surface of the retaining roller to mechanically retain the recording medium. The retaining device retains the recording medium on the surface of the retaining roller. The controller controls, on the basis of a condition for use of the recording medium, the nipping device to nip the recording medium between the nipping device and the surface of the retaining roller.

### CROSS-REFERENCE TO RELATED APPLICATIONS

This application claims the benefit of U.S. Provisional Applications No. 61/384,056, filed on Sep. 17, 2010.

### FILED

Embodiments described herein relate generally to an image forming apparatus and an image forming method.

### BACKGROUND

As an image forming apparatus, there is an image forming apparatus that rotates a retaining roller with a recording medium such as a sheet retained on a surface thereof to thereby convey the recording medium along an outer circumference of the retaining roller and performs image formation on the recording medium in a head provided in an outer circumferential portion of the retaining roller. In this image forming apparatus, for example, the recording medium is retained on the surface of the retaining roller by an attraction mechanism configured to use electrostatic attraction or negative pressure suction. There is also known an image forming apparatus that retains a recording medium on a surface of a retaining roller using a mechanical nipping mechanism in order to improve a retaining function. Such a mechanical nipping mechanism could be a cause of an impact on the retaining roller in a nipping operation.

### BRIEF DESCRIPTION OF THE DRAWINGS

FIG. 1 is a side view of the configuration of an inkjet recording apparatus according to an embodiment;

FIG. 2 is a perspective view of the vicinity of a nipping device of the inkjet recording apparatus according to the embodiment;

FIGS. 3A and 3B are explanatory diagrams of the operation of the nipping device of the inkjet recording apparatus according to the embodiment;

FIG. 4 is a block diagram of the configuration of the inkjet recording apparatus according to the embodiment;

FIG. 5 is a flowchart for explaining the operation of the inkjet recording apparatus according to the embodiment;

FIG. 6 is a side view of the configuration of an inkjet recording apparatus according to another embodiment;

FIG. 7 is a perspective view of the vicinity of a nipping device of the inkjet recording apparatus according to the other embodiment;

FIG. 8 is a block diagram of the configuration of the inkjet recording apparatus according to the other embodiment; and

FIG. 9 is a flowchart for explaining the operation of the inkjet recording apparatus according to the other embodiment.

### DETAILED DESCRIPTION

According to one embodiment, an image forming apparatus includes a retaining roller, a nipping device, a retaining device, an image forming head, and a controller. The retaining roller retains a recording medium on a surface of the retaining roller and rotates. The nipping device is capable of operating to open and close and holds the recording medium between the nipping device and the surface of the retaining roller to mechanically retain the recording medium. The retaining device different from the nipping device retains the recording medium on the surface of the retaining roller. The image forming head is provided to be opposed to an outer circumferential surface of the retaining roller and forms an image on the recording medium retained on the surface of the retaining roller. The controller controls, on the basis of a condition for use of the recording medium, the nipping device to nip the recording medium between the nipping device and the surface of the retaining roller.

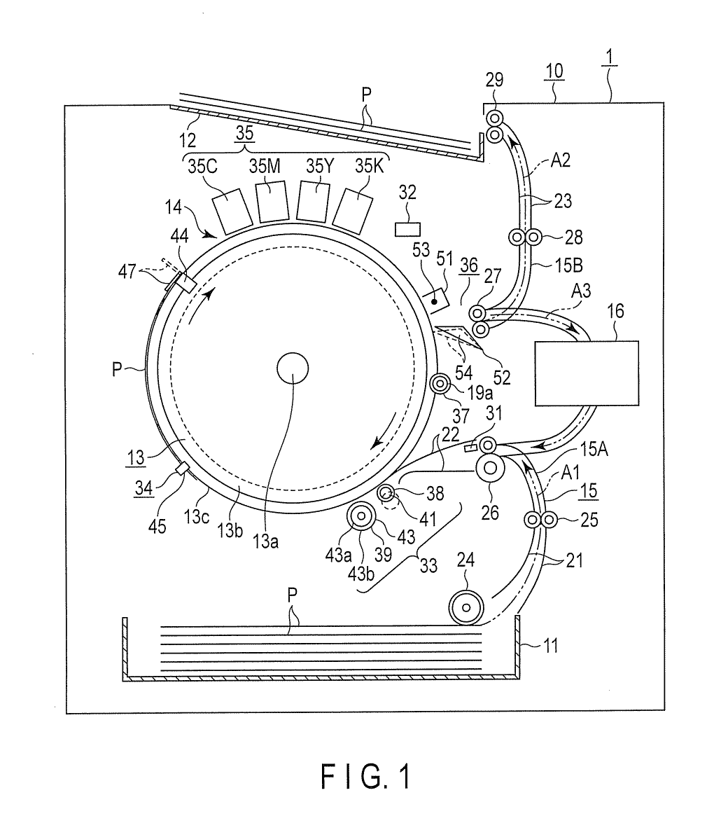

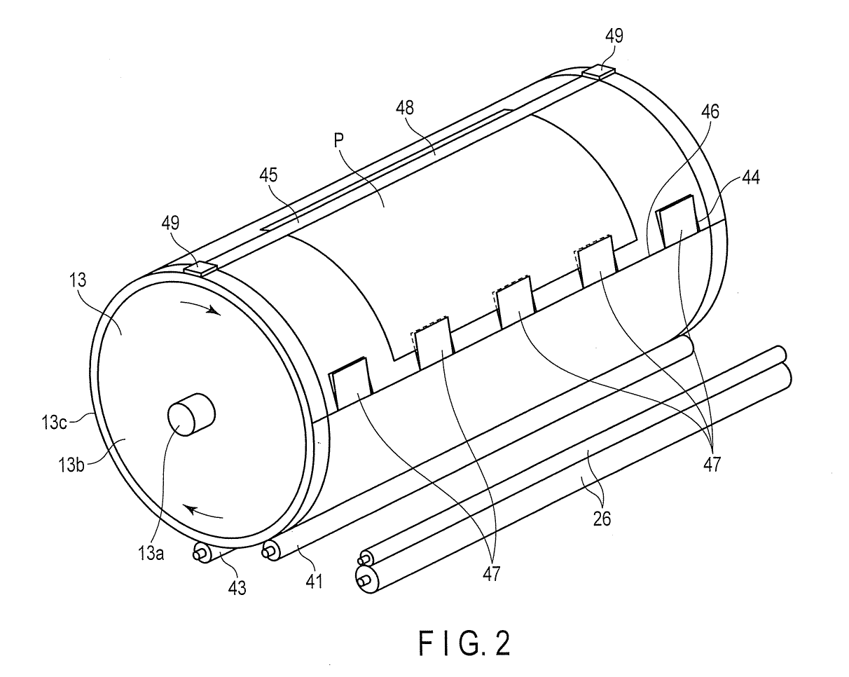

An inkjet recording apparatus 1 according to an embodiment is explained below. In the figures, components are expanded, reduced, or omitted as appropriate to schematically show the components. FIG. 1 is an explanatory diagram of a mechanism of the inkjet recording apparatus 1 (an image forming apparatus) according to this embodiment. FIG. 2 is a perspective view of the vicinity of a nipping device 34 of the inkjet recording apparatus 1.

The inkjet recording apparatus 1 shown in FIG. 1 is, for example, an apparatus that performs various kinds of processing such as image formation while conveying a sheet P, which is a recording medium. The inkjet recording apparatus 1 includes a housing 10 that forms an outer hull, a paper feeding cassette 11 functioning as a sheet feeding section provided on the inside of the housing 10, a paper discharge tray 12 functioning as a discharge section provided in an upper part of the housing 10, an image forming section 14 including a retaining roller (a drum) 13 configured to retain the sheet P on an outer surface thereof and rotate, a conveying device 15 configured to convey the sheet P along conveying paths A1 and A2 from the paper feeding cassette 11 to the drum 13 and from the drum 13 to the discharge section, and a reversing device 16 configured to reverse front and rear surfaces of the sheet P peeled off the drum 13 and feed the sheet P onto the surface of the drum 13 again.

The conveying device 15 includes a paper feeding device 15A configured to convey the sheet P from the paper feeding cassette 11 to the drum 13 along the predetermined conveying path A1 and a paper discharging device 15B configured to convey the sheet P from the drum 13 to the paper discharge tray 12 along the predetermined conveying path A2.

The paper feeding device 15A includes plural guide members 21 and 22 and plural conveying rollers 24, 25, and 26 provided along the conveying path A1. As the conveying rollers, a pickup roller 24, a paper feeding roller pair 25, and a registration roller pair 26 are provided.

The paper discharging device 15B includes plural guide members 23 and plural conveying rollers 27, 28, and 29 provided along the conveying path A2. As the conveying rollers, a separating roller pair 27, a conveying roller pair 28, and a discharge roller pair 29 are provided.

A sheet position sensor 31 configured to detect a leading end position of the sheet P is provided near a nip of the registration roller pair 26 in the conveying path A1. An operation panel 59 on which various items can be set by a user is provided. A temperature sensor 32 functioning as a temperature detecting section configured to detect the temperature in the apparatus 1 is provided in the apparatus 1. Besides, sensors and the like for monitoring a conveyance state of a sheet are arranged in various places.

The image forming section 14 includes, besides the drum 13, in order from an upstream side to a downstream side starting from a position where the guide member 22 and the drum 13 are in close contact with each other in an outer circumferential portion of the drum 13, a first retaining device 33 configured to retain the sheet P on the surface of the drum 13, the nipping device 34 configured to nip and retain the sheet P on the surface of the drum 13, an inkjet unit 35 configured to form an image on the sheet P retained on the outer surface of the drum 13, an electricity removing and peeling device 36 configured to remove electricity of the sheet P and peel the sheet P off the drum 13, and a cleaning device 37 configured to clean the drum 13.

The drum 13 includes a rotating shaft 13a, a cylindrical frame 13b formed of aluminum, which is a conductor, in a cylindrical shape, and a thin insulating layer 13c formed on a surface of the cylindrical frame 13b. The drum 13 is formed in a cylindrical shape having fixed length in an axis direction thereof. The cylindrical frame 13b is grounded. The cylindrical frame 13b functions as a counter electrode and a potential of the cylindrical frame 13b is maintained at 0 V during charging by a charging roller 43.

The retaining device 33 includes a pressing device 38 configured to press the sheet P against the drum 13 and an attracting device 39 configured to attract the sheet P to the drum 13 with electrostatic force by charging on the downstream side of the pressing device 38 with respect to a direction in which the sheet P is conveyed.

The pressing device 38 includes a pressing roller 41 (a pressing member) arranged to be opposed to the surface in a lower part of the drum 13. A shaft of the pressing roller 41 extends in parallel to the rotating shaft 13a of the drum 13. An outer circumferential surface of the pressing roller 41 is covered with an insulating layer made of an insulating material to prevent charges of the charged sheet P from leaking through the pressing roller 41.

As shown in FIG. 1, a position of the pressing roller 41 is configured to be movable in plural stages in the radial direction of the drum 13. The pressing roller 41 can be switched, according to the position of the pressing roller 41, between a pressing state in which the pressing roller 41 presses the surface of the drum 13 with a first pressing force as indicated by a solid line in FIG. 1 and a release state in which the pressing roller 41 separates from the drum 13 and the pressing force is released as indicated by a broken line in FIG. 1.

The attracting device 39 includes the charging roller 43 arranged adjacent to and on the downstream side of the pressing roller 41. The charging roller 43 includes a charging shaft 43a of metal extending in parallel to the rotating shaft 13a of the drum 13 and a surface layer 43b formed on an outer circumference of the charging shaft 43a. The charging roller 43 is arranged to be opposed to the surface of the drum 13. A supply state of charges to the charging roller 43 can be switched and the charging roller 43 can be moved in a direction in which the charging roller 43 approaches and separates from the surface of the drum 13.

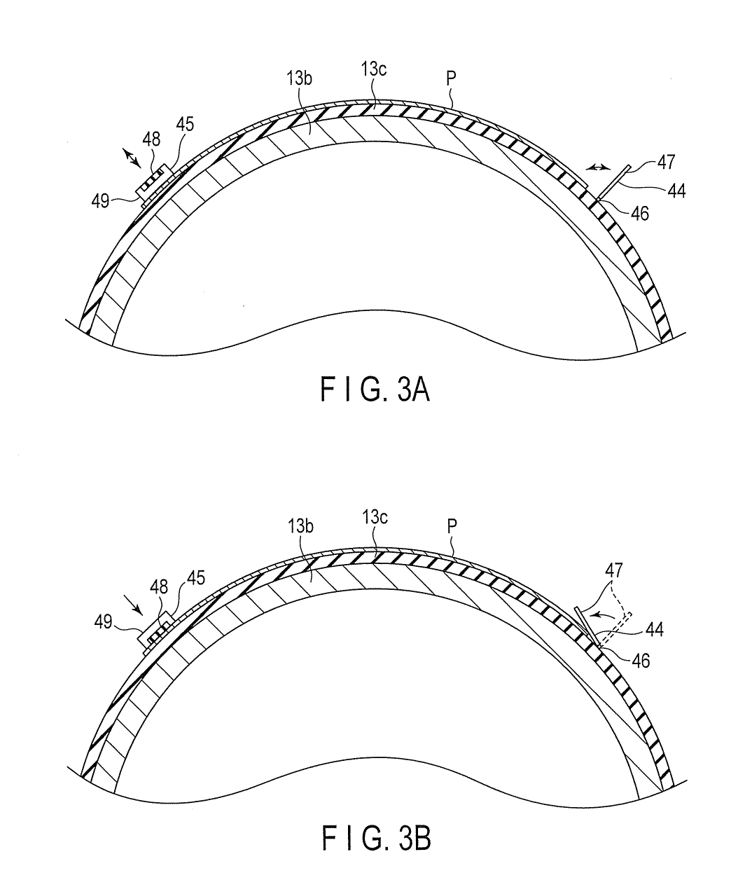

The nipping device 34 includes a first gripper 44 configured to nip a leading end of the sheet P and a second gripper 45 configured to nip a trailing end of the sheet P. FIGS. 3A and 3B are explanatory diagrams of the nipping device 34. An open state in which the nipping device 34 releases the nipping of the sheet P is shown in FIG. 3A. A closed state in which the nipping device 34 nips the sheet P is shown in FIG. 3B.

The first gripper 44 is provided to be fixed in the outer circumferential portion of the drum 13 and moves according to the rotation of the drum 13. The first gripper 44 includes an arm 46 extending in the axis direction of the drum 13 and plural nipping pieces 47 attached to the arm 46. The arm 46 extends over the entire width of the drum 13 and fixed to ends of the drum 13 at both ends 46a and 46b in the width direction of the arm 46. Five nipping pieces 47 are provided in the arm 46. The nipping pieces 47 are capable of operating to open and close by pivoting about the arm 46. For prevention of a leak during charging, the arm 46 and the nipping pieces 47 are formed of an insulating material such as PPS (polyphenylene sulfide).

The first gripper 44 can be switched, according to an angle of the nipping pieces 47, between a closed state in which the first gripper 44 presses the sheet P against the drum 13 along the circumferential direction on the surface of the drum 13 as indicated by a solid line in FIG. 1 and an open state in which the first gripper 44 stands in the radial direction from the drum 13 and releases nipping as indicated by a broken line in FIG. 1.

The second gripper 45 is provided to be movable in the circumferential direction along the outer circumferential surface of the drum 13 in the outer circumferential portion of the drum 13. The second gripper 45 includes a band 48 extending in the axis direction of the drum 13 and a pair of fixing pieces 49 that fix the band 48 to ends of the drum 13 at both ends in the width direction of the band 48. The band 48 is configured to be movable in the radial direction of the drum 13. For prevention of a leak during charging, the band 48 is formed of an insulating material such as PPS.

As shown in FIG. 1, the second gripper 45 can be switched, according to a position of the band 48, between a closed state in which the second gripper 45 presses the sheet P against the surface of the drum 13 and nips the sheet P as indicated by a solid line in FIG. 1 and an open state in which the second gripper 45 separates from the surface of the drum 13 in the radial direction, forms a space between the band 48 and the drum 13, and releases the nipping as indicated by a broken line in FIG. 1.

Referring back to FIG. 1, the inkjet unit 35 (an image forming unit) including plural inkjet heads is arranged in an upper part of the surface of the drum 13 and on the opposite side of the charging roller 43 across the drum 13. The inkjet unit 35 is arranged to be opposed to the drum 13. The inkjet unit 35 is arranged on the downstream side with respect to a position where the guide member 22 and the drum 13 are in close contact with each other.

The inkjet head unit 35 includes inkjet heads 35c, 35m, 35y, and 35k. The inkjet heads 35c, 35m, 35y, and 35k for four colors of cyan, magenta, yellow, and black are respectively provided. The inkjet heads 35c, 35m, 35y, and 35k for the four colors eject inks to the sheet P from nozzles provided at a predetermined pitch to form an image.

The electricity removing, and peeling device 36 includes an electricity removing device 51 configured to remove electricity of the sheet P and a peeling device 52 configured to peel the sheet P off the surface of the drum 13 after the electricity removal.

The electricity removing device 51 is provided further on the downstream side than the inkjet unit 35 with respect to the position where the guide member 22 and the drum 13 are in close contact with each other. The electricity removing device 51 includes a chargeable electricity removing roller 53. The electricity removing device 51 supplies charges to the sheet P to remove electricity of the sheet P to release attraction force and make it easy to peel the sheet P off the drum 13.

The peeling device 52 is provided further on the downstream side than the electricity removing device 51 with respect to the position where the guide member 22 and the drum 13 are in close contact with each other. The peeling device 52 includes a pivotable (movable) separation claw 54. The separation claw 54 can pivot between a peeling position where the separation claw 54 is inserted between the sheet P and the drum 13 and a retracted position where the separation claw 54 retracts from the drum 13. In a state in which the separation claw 54 is arranged in the peeling position, the separation claw 54 peels the sheet P off the surface of the drum 13. In FIG. 1, the state in which the separation claw 54 is present in the peeling position is indicated by a broken line and a state in which the separation claw 54 is present in the retracted position is indicated by a solid line.

The cleaning device 37 is provided further on the downstream side than the peeling device 52 with respect to the position where the guide member 22 and the drum 13 are in close contact with each other.

The reversing device 16 is provided between the conveying path A1 and the conveying path A2. The reversing device 16 reverses the sheet P peeled by the peeling device 52 and feeds the sheet P onto the surface of the drum 13 again. As the reversing device 16, any well-known mechanism such as a mechanism for switching back the sheet P to be reversed in a front-back direction may be used.

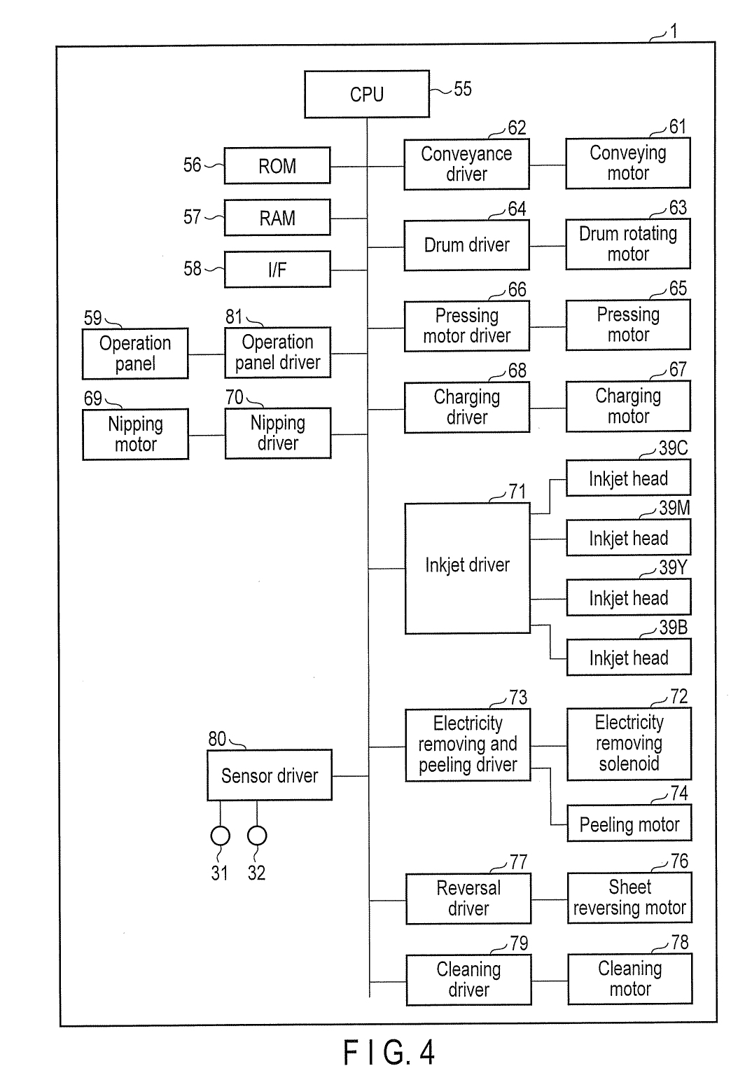

As shown in FIG. 4, the inkjet recording apparatus 1 includes a CPU (central processing unit) 55, which is a controller, a ROM (read only memory) 56 having stored therein various computer programs and the like, a RAM (random access memory) 57 configured to temporarily store various variable data, image data, and the like, and an interface (I/F) 58 configured to receive input of data from the outside and output data to the outside.

The inkjet recording apparatus 1 includes a conveying motor control driving circuit (driver) 62 configured to control a conveying roller motor 61 coupled to the rollers 24 to 29 functioning as the conveying rollers, a drum control driving circuit (driver) 64 configured to control a drum rotating motor 63 coupled to the drum 13, a pressing motor control driving circuit (driver) 66 configured to control a pressing motor 65 coupled to the pressing roller 41, a charging control driving circuit (driver) 68 configured to control a charging motor 67 connected to the charging roller 43 to supply charges to the charging roller 43 and bring the charging roller 43 into contact with and separate the charging roller 43 from the drum 13, a nipping motor control driving circuit (driver) 70 configured to control a nipping motor 69 coupled to the first gripper 44 and the second gripper 45 of the nipping device 34, an image formation control driving circuit (driver) 71 configured to control the inkjet heads 35c, 35m, 35y, and 35k, an electricity removing and peeling control driving circuit (driver) 75 configured to control an electricity removing solenoid 72 connected to the separation claw 54 and control a peeling motor 74 coupled to the separation claw 54, a reversal control driving circuit (driver) 77 configured to control a sheet reversing motor 76 coupled to the reversing device 16, a cleaning control driving circuit (driver) 79 configured to control a cleaning motor 78 coupled to a cleaning member 19a, a sensor control driving circuit (driver) 80, and an operation panel control driving circuit (driver) 81 configured to control the operation panel 59.

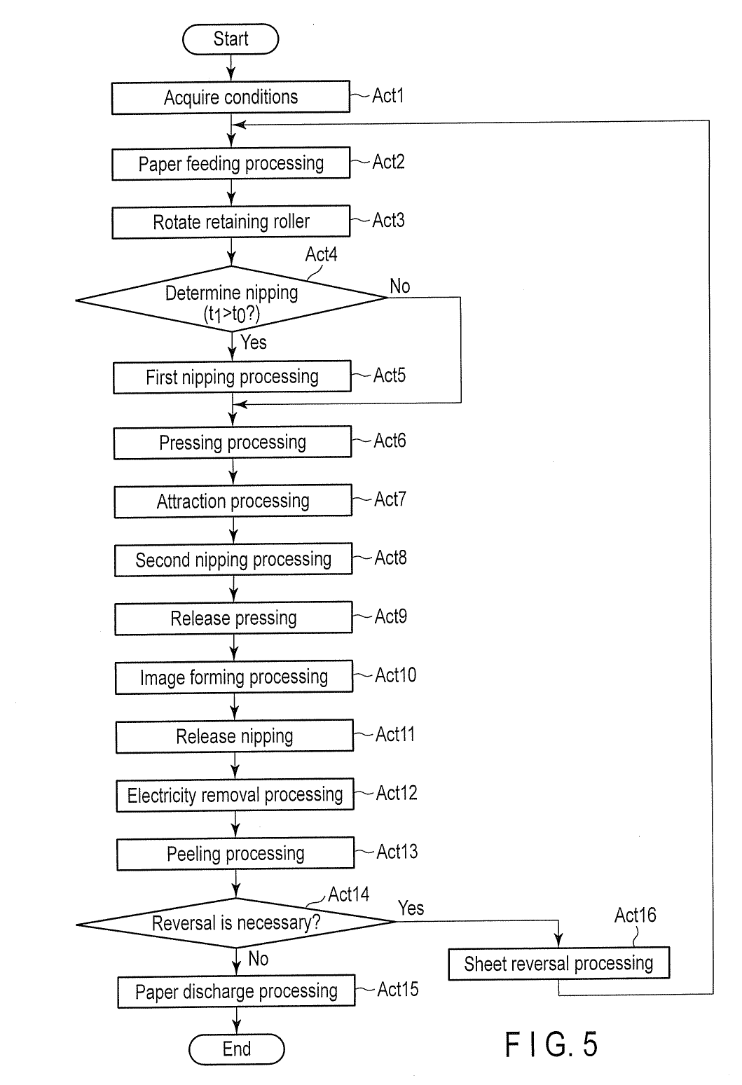

Actions of the inkjet recording apparatus 1 according to this embodiment are explained below with reference to a flowchart of FIG. 5.

First, the CPU 55 detects various conditions for use (Act 1). The conditions for use are, for example, a printing ratio besides necessity of duplex printing. The CPU 55 detects these conditions from information detected by the sensor 31 or information input from the interface 58.

The CPU 55 detects conditions such as a printing mode of duplex printing or simplex printing, the resolution of image formation, and a color mode via the interface 58 on the basis of, for example, a setting input by a user.

The CPU 55 determines a printing ratio, a color, and a printing speed on the basis of information concerning an image to be printed and information such as resolution. Besides, the CPU 55 detects conditions for use such as thickness t1, the size, and the position of the sheet P and the temperature in the apparatus with the sensors 31 and 32.

Subsequently, the CPU 55 instructs the conveying roller control driving circuit 62 to perform paper feeding processing (Act 2). Consequently, the pickup roller 24, the paper feeding roller pair 25, and the registration roller pair 26 functioning as paper feeding rollers are driven to rotate to send one sheet P from a sheet bundle stacked on the paper feeding cassette 11 along the conveying path A1 and feed the sheet onto the surface of the drum 13.

At predetermined timing when the sheet P is fed onto the surface of the drum 13, the CPU 55 instructs the drum control driving circuit (driver) 64 to rotate the drum 13 (Act 3).

The CPU 55 determines, on the basis of the various conditions for use detected in Act 1, whether the nipping device 34 is actuated (Act 4). As an example, the CPU 55 compares the thickness t1 of the sheet P and a threshold t0 set in advance. At the timing for the determination in Act 4, the first gripper 44 is in the closed state, i.e., a state in which there is no level difference between a surface on the outer side of the first gripper 44 and the outer circumferential surface of the drum 13.

If the CPU 55 determines that the thickness t1 of the sheet P is larger than the threshold t0 (Y in Act 4) the CPU 55 instructs the nipping motor control driving circuit (driver) 70 to change the first gripper 44 to the open state once. At predetermined timing when the leading end of the sheet P is located between the drum 13 and the first gripper 44, the CPU 55 instructs the nipping motor control driving circuit (driver) 70 to change the first gripper 44 to the closed state (Act 5). Further, at the same timing for instructing the nipping motor control driving circuit (driver) 70 to change the first gripper 44 to the open state, the CPU 55 instructs the nipping motor control driving circuit (driver) 70 to change the second gripper 45 to the open state as well (Act 5 of first nipping processing).

Immediately before the leading end of the sheet P is fed onto the surface of the drum 13, the first gripper 44 stays on standby in a predetermined position on the upstream side of the pressing roller 41 with respect to the position where the guide member 22 and the drum 13 are in close contact with each other in the outer circumferential portion of the drum 13. In other words, the first gripper 44 is located between the position where the guide member 22 and the drum 13 are in close contact with each other and the pressing roller 41. When the first gripper 44 is present in this position, the first gripper 44 is in the open state. The second gripper 45 stays on standby in a predetermined position further on the upstream side than the first gripper 44. In other words, the second gripper 45 is located further on the front side than the position between the position where the guide member 22 and the drum 13 are in close contact with each other and the pressing roller 41.

On the other hand, if the CPU 55 determines that the thickness t1 of the sheet P is equal to or smaller than the threshold tO0 (N in Act 4), the CPU 55 does not cause the first gripper 44 and the second gripper 45 to operate while keeping the first gripper 44 and the second gripper 45 in the open state and proceeds to Act 6 explained later.

At predetermined timing when the sheet P rushes into a nip of the pressing roller 41, the CPU 55 instructs the pressing motor control driving circuit (driver) 66 to cause the pressing roller 41 to press the drum 13 with predetermined pressing force (Act 6). Consequently, the position of the pressing roller 41 is set in a first state.

First, the sheet P fed by the registration roller pair 26 twines around and adheres to the drum 13 while unevenness such as creases is smoothed by the pressing roller 41. The sheet P passes through a nip between the pressing roller 41 and the drum 13 and immediately rushes into a nip of the charging roller 43 in the downstream side.

The CPU 55 instructs the charging control driving circuit 68 to generate electrostatic force in a nip between the charging roller 43 and the drum 13 and attract the sheet P (Act 7). Timing for charging is set such that, for example, the charging roller 43 is charged immediately before the sheet P reaches the charging roller 43 according to the rotation of the drum 13. The sheet P is directly conveyed to the inkjet unit 35 according to the rotation of the drum 13 in a state in which the sheet P is nipped by the nipping device 34 and attracted to and retained on the drum 13 by static electricity.

The CPU 55 instructs the nipping motor control driving circuit (driver) 70 to change the second gripper 45 to the closed state at timing when the trailing end of the sheet P is located between the second gripper 45 and the drum 13 (Act 8 of second nipping processing). Timing for changing the second gripper 45 to the closed state in Act 8 is limited to this timing. However, timing for changing the second gripper 45 to the open state is not the same as the timing for changing the first gripper 44 to the open state. The second gripper 45 only has to be changed to the open state before the second gripper 45 reaches the position where the guide member 22 and the drum 13 are in close contact with each other in the outer circumferential portion of the drum 13.

At predetermined timing when the trailing end of the sheet P moves further to the downstream side than the pressing roller 41, the CPU 55 instructs the pressing motor control driving circuit 66 to retract the pressing roller 41 (Act 9).

Subsequently, the CPU 55 performs image forming processing (Act 10). In the image forming processing, the CPU 55 instructs the image formation control driving circuit 71 to cause the inkjet heads 35c, 35m, 35y, and 35k to eject the inks to the front surface of the sheet P and perform printing. At this point, image formation is performed according to various conditions such as resolution and a printing mode. The drum 13 is rotated plural times while the sheet P is kept attracted thereto to repeat the image forming operation by the inkjet heads 35c, 35m, 35y, and 35b plural times according to necessity. A necessary number of revolutions and a necessary number of times of ejection are determined according to, for example, a relation between a nozzle pitch of the inkjet heads 35c, 35m, 35y, and 35b and resolution. If the drum 13 is rotated plural times while the sheet P is kept attracted to the drum 13, the separation claw 54 of the peeling device 52 and the cleaning member 19a of the cleaning device 37 are set in retracted positions to allow conveyance of the sheet P.

After the end of the image forming processing, the CPU 55 instructs the nipping motor control driving circuit (driver) 70 to release the nipping by the nipping device 34 (Act 11). At this point, the CPU 55 pivots the nipping pieces 47 of the first gripper 44 to a release position and moves the band 48 of the second gripper 45 to separate the band 48 from the drum 13. As timing for releasing the nipping, the CPU 55 causes the nipping device 34 to perform a nipping release operation after the image formation by the inkjet unit 35.

The CPU 55 instructs the electricity removing and peeling control driving circuit (driver) 75 to drive the electricity removing device 51 arranged on the downstream side of the inkjet unit 35 (Act 12) to thereby remove electricity of the sheet P and release electrostatic attraction force.

Further, the CPU 55 instructs the electricity removing and peeling control driving circuit (driver) 75 to drive the peeling device 52 on the downstream side (Act 13) to thereby peel the sheet P off the surface of the drum 13.

The CPU 55 determines whether a reversal of the sheet P is necessary (Act 14). If the CPU 55 determines that the reversal of the sheet P is unnecessary (NO in Act 14), the CPU 55 instructs the conveying motor control driving circuit (driver) 62 to perform paper discharge processing (Act 15). The CPU 55 determines that the reversal is unnecessary, for example, during simplex printing setting or after image formation on both the front and rear surfaces ends during duplex printing setting. As the paper discharge processing, the sheet P is guided to the conveying path A2 leading to the paper discharge tray 12 in the upper part by switching of the separating roller pair 27 and discharged to the paper discharge tray 12 by the conveying roller pair 28 and the paper discharge roller pair 29.

On the other hand, if the CPU 55 determines that the reversal of the sheet P is necessary (YES in Act 14), the CPU 55 instructs the reversal control driving circuit (driver) 77 to cause the reversing device 16 to perform reversal processing (Act 16). As the reversal processing, processing for guiding, by switching the separating roller pair 27, the sheet P to a conveying path A3 leading to the reversing device 16 and causing the reversing device 16 to reverse the front and rear surfaces of the sheet P is performed. The reversing device 16 reverses the front and rear surfaces of the sheet P by, for example, temporarily storing the sheet P and guiding, from the trailing end, the sheet P to a reversing path for switching back the sheet P.

After the reversal processing, the CPU 55 returns to Act 2. The CPU 55 performs the processing in Acts 3 to 14 again. Since the reversal is unnecessary after the image forming processing on the rear surface ends, the CPU 55 determines that the reversal is unnecessary (NO in Act 14) and performs the paper discharge processing (Act 15).

With the inkjet recording apparatus 1 and the inkjet recording method according to this embodiment, it is possible to minimize the influence of the nipping device 34 on the drum 13 by determining, on the basis of the conditions for use, whether the nipping device 34 is actuated. In other words, the nipping device 34 is actuated only when necessary on the basis of, for example, conditions including any one of the temperature in the apparatus, the humidity in the apparatus, a printing speed, a printing ratio, a printing color, resolution, the thickness of the recording medium, the size of the recording medium, the volume resistance of the recording medium, and the front or rear surface of the recording medium. The nipping device 34 is not actuated if the sheet P can be retaining only by attraction and retaining. Therefore, it is possible to suppress an impact of the opening and closing operation by the nipping device 34 on the drum 13. Consequently, it is possible to stably perform high-quality image formation.

Timing for the opening and closing operation by the nipping device 34 is before and after the image formation by the inkjet unit 35. Timing during the image formation is avoided. Therefore, it is possible to more stably perform the image forming processing.

The present invention is not limited to the embodiment and can be modified as appropriate. In the embodiment, the thickness of a sheet is explained as an example of the conditions. However, the conditions are not limited to this. The nipping processing may be adjusted on the basis of other conditions.

As the other conditions, for example, various conditions such as a printing ratio, a color, a printing speed, resolution, a printing color, the temperature in the apparatus, the humidity in the apparatus, and the front or rear surface of the sheet may be set as a reference. If the temperature in the apparatus is higher than a threshold, if the humidity in the apparatus is higher than a threshold, if the printing speed is higher than a threshold, if the printing ratio is higher than a threshold, if the printing color is black or cyan, if the resolution is higher than a threshold, if the size of the sheet P is larger than a threshold, if the volume resistance of the sheet P is higher than a threshold, or if an image is formed on the rear surface of a sheet, on the front surface of which an image is formed, the nipping device 34 is controlled to be changed to the closed state. This makes it possible to actuate the nipping device 34 only if mechanical nipping is necessary. Effects same as those in the embodiment can be obtained.

In the embodiment, the attracting device 39 configured to generate electrostatic force to attract the sheet P to the drum 13 is explained as an example. However, the present invention is not limited to this. Besides, other configurations such as attraction by negative pressure suction may be adopted.

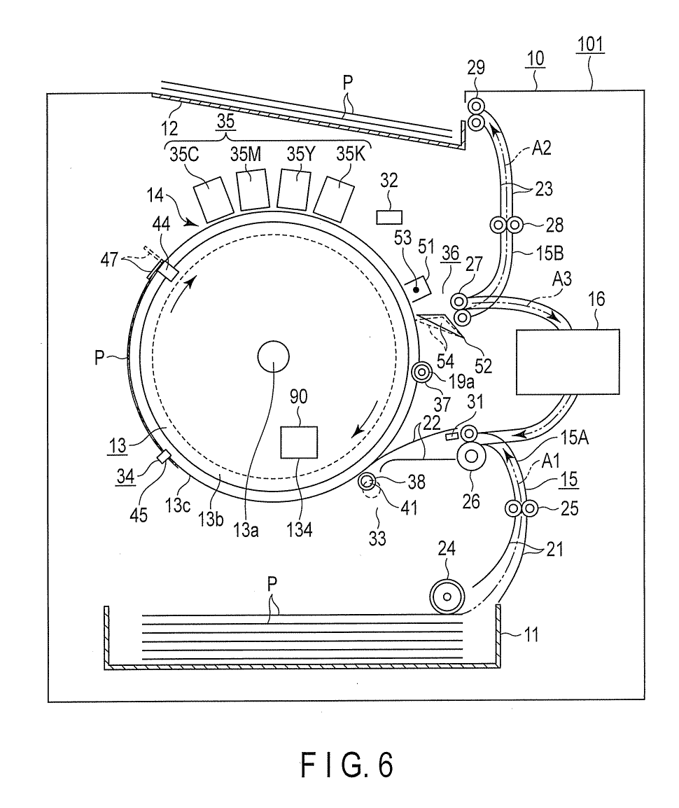

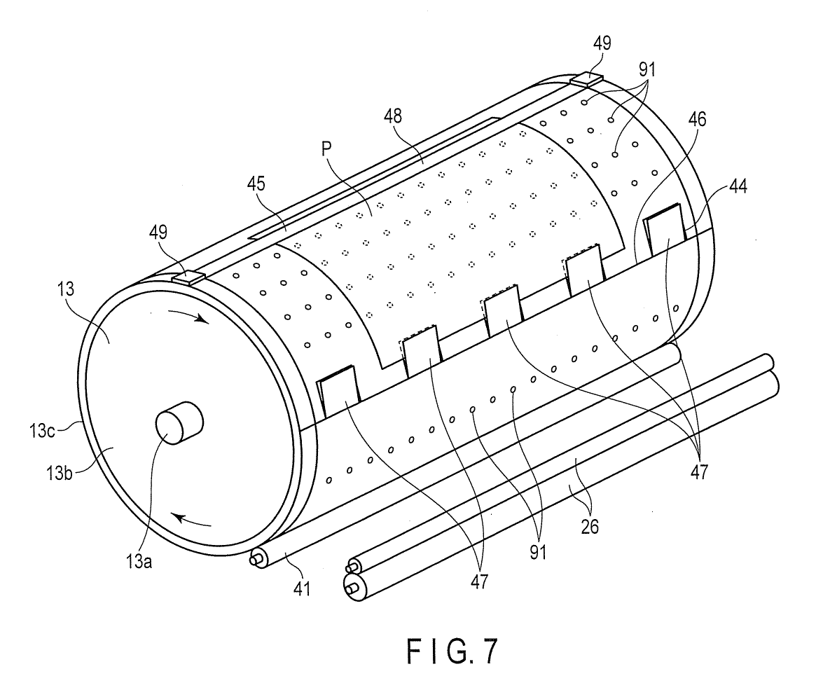

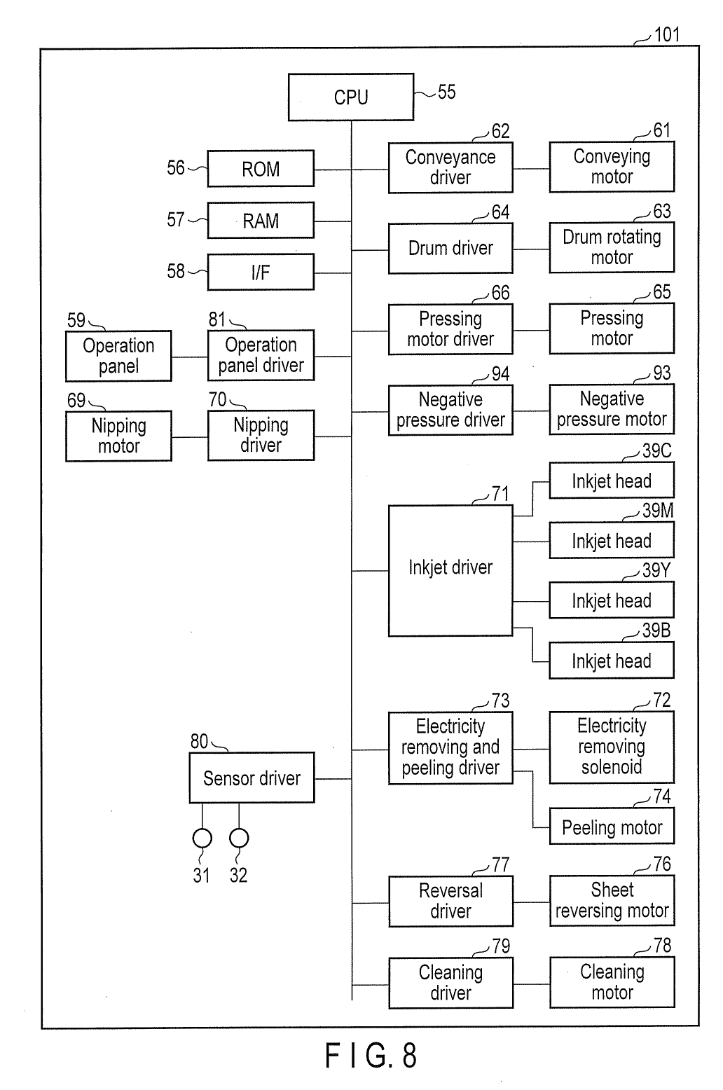

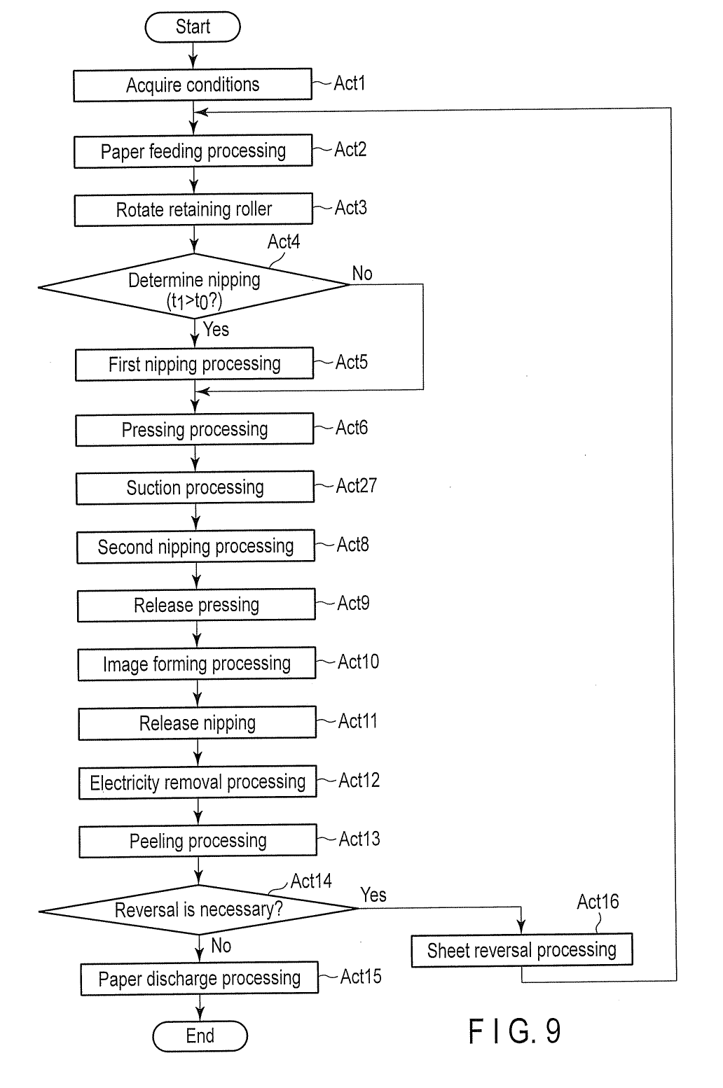

The configuration of an inkjet recording apparatus 101 including a suction device 34 by negative pressure suction is shown in FIG. 6 as another embodiment. FIG. 7 is a perspective view of the vicinity of a retaining device of the inkjet recording apparatus 101 according to the other embodiment. FIG. 8 is a block diagram of the configuration of the inkjet recording apparatus 101 according to the other embodiment. FIG. 9 is a flowchart for explaining the operation of the inkjet recording apparatus 101 according to the other embodiment. Components same as those in the embodiment explained above are denoted by the same reference numerals and signs and explanation of the components is omitted. As shown in FIGS. 6 and 7, the inkjet recording apparatus 101 includes a negative pressure generating device 90 functioning as the suction device 34 and plural negative pressure holes 91 formed in the drum 13. The inkjet recording apparatus 101 includes the pressing device 38 as the retaining device 33. However, the inkjet recording apparatus 101 does not include the attracting device 39 configured to supply charges and includes the suction device 34 instead of the attracting device 39. The suction device 34 includes a not-shown fan. The suction device 34 has a function of turning the fan to decompress the inside of the drum 13 and sucking the sheet P retained on the outer circumferential surface of the drum 13. As shown in FIG. 8, in order to drive the suction device 34, the inkjet recording apparatus 101 includes a negative pressure motor driver 94 configured to control a negative pressure motor 93 connected to the fan. Conversely, the inkjet recording apparatus 101 does not include a charging motor and a charging driver configured to drive the charging motor and supply charges.

Since Acts 1 to 6 are the same as those in the embodiment explained above as shown in FIG. 9, explanation of the acts is omitted. After Act 6, the CPU 55 instructs the negative pressure motor driver 94 to drive the negative pressure motor 93 in order to decompress the inside of the drum 13 (suction processing, Act 27). Since Acts 7 to 16 are the same as those in the embodiment explained above, explanation of the acts is omitted. The negative pressure processing does not need to be performed at timing of Act 27. The CPU 55 may control the negative pressure motor driver 94 to always drive the negative pressure motor 93 during the operation of the flowchart. Effects same as those in the embodiment explained above can be obtained.

As still another embodiment, if the CPU 55 determines that the nipping operation is necessary (Y in Act 4), the CPU 55 may control to reduce a printing speed in order to prevent the impact of the drum 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a retaining roller configured to retain a recording medium on a surface of the retaining roller and rotate;
a nipping device capable of operating to open and close and configured to hold the recording medium between the nipping device and the surface of the retaining roller in a closed state to mechanically retain the recording medium;
a retaining device different from the nipping device and configured to retain the recording medium on the surface of the retaining roller;
an image forming unit provided to be opposed to an outer circumferential surface of the retaining roller and configured to form an image on the recording medium retained on the surface of the retaining roller; and
a controller configured to control, on the basis of a condition for use of the recording medium, the nipping device to nip the recording medium between the nipping device and the surface of the retaining roller.

2. The apparatus according to claim 1, wherein the condition for use includes at least any one of temperature in the apparatus, humidity in the apparatus, a printing speed, a printing ratio, a printing color, resolution, thickness of the recording medium, a size of the recording medium, volume resistance of the recording medium, and a front or rear surface of the recording medium.

3. The apparatus according to claim 1, wherein the nipping device includes:
a first gripper provided in an outer circumferential portion of the roller and configured to hold the recording medium between the first gripper and the surface of the roller and nip the recording medium; and
a second gripper configured to hold the recording medium between the second gripper and the surface of the roller and nip the recording medium further on a downstream side than the first gripper in the outer circumferential portion of the roller.

4. The apparatus according to claim 1, wherein the controller controls the nipping device to perform, if thickness of the recording medium is larger than a threshold, nipping processing for nipping the recording medium and not to perform, if the thickness of the recording medium is equal to or smaller than the threshold, the nipping processing for nipping the recording medium.

5. The apparatus according to claim 1, wherein the controller controls the nipping device to perform, if a printing ratio of the image formation is higher than a threshold, nipping processing for nipping the recording medium and not to perform, if the printing ratio is equal to or lower than the threshold, the nipping processing for nipping the recording medium.

6. The apparatus according to claim 1, wherein the controller controls the nipping device to perform, if a rotating speed of the retaining roller is higher than a threshold, nipping processing for nipping the recording medium and not to perform, if the rotating speed is equal to or lower than the threshold, the nipping processing for nipping the recording medium.

7. The apparatus according to claim 1, wherein
the image forming unit includes plural inkjet heads configured to respectively supply inks of plural colors of cyan, magenta, yellow, and black, and
the controller controls, according to a color of printing, the nipping device to perform, if the printing is performed in the color of cyan or black, nipping processing for nipping the recording medium and not to perform, if the printing is performed in the color of magenta or yellow, the nipping processing for nipping the recording medium.

8. The apparatus according to claim 1, further comprising a reversing device configured to reverse front and rear surfaces of the recording medium after forming an image on a first surface of the recording medium, wherein
the controller controls the nipping device to perform, in a state in which the first surface of the recording medium is faced to an outer side, nipping processing for nipping the recording medium and not to perform, if the recording medium is reversed after the image formation on the first surface and retained in a state in which a second surface is faced to the outer side, the nipping processing for nipping the recording medium.

9. The apparatus according to claim 1, wherein the retaining device includes an attracting device arranged to be opposed to the retaining roller and including a charging member configured to attract the recording medium to the retaining roller with static electricity.

10. The apparatus according to claim 1, wherein the retaining device includes a negative pressure suction device configured to attract the recording medium to the retaining roller with negative pressure.

11. The apparatus according to claim 1, wherein the controller controls to reduce a printing speed if nipping processing for nipping the recording medium is performed.

12. An image forming method comprising:
controlling, on the basis of a condition for use of a recording medium, an opening and closing operation of a nipping device provided on a retaining roller, which retains the recording medium on a surface of the retaining roller, and configured to mechanically nip the recording medium between the nipping device and the surface of the retaining roller according to the opening and closing operation;
attracting and retaining the recording medium on the surface of the retaining roller with a device different from the nipping device; and
forming an image on the recording medium retained on the surface of the retaining roller.

13. The method according to claim 12, wherein the condition for use includes at least any one of temperature in the apparatus, humidity in the apparatus, a printing speed, a printing ratio, a printing color, resolution, thickness of the recording medium, a size of the recording medium, volume resistance of the recording medium, and a front or rear surface of the recording medium.

14. The method according to claim 12, further controlling the nipping device to perform, if thickness of the recording medium is larger than a threshold, nipping processing for nipping the recording medium and not to perform, if the thickness of the recording medium is equal to or smaller than the threshold, the nipping processing for nipping the recording medium.

15. The method according to claim 12, wherein the attracting and retaining is electrostatic attraction for attracting the recording medium to the retaining roller with static electricity.

16. A sheet processing apparatus comprising:
a retaining roller configured to retain a recording medium on a surface of the retaining roller and rotate;
a nipping device capable of operating to open and close and configured to hold the recording medium between the nipping device and the surface of the retaining roller in a closed state to mechanically retain the recording medium;
a retaining device different from the nipping device and configured to retain the recording medium on the surface of the retaining roller; and
a controller configured to control, on the basis of a condition for use of the recording medium, the nipping device to nip the recording medium between the nipping device and the surface of the retaining roller.

17. The apparatus according to claim 16, wherein the condition for use includes at least any one of temperature in the apparatus, humidity in the apparatus, a printing speed, a printing ratio, a printing color, resolution, thickness of the recording medium, a size of the recording medium, volume resistance of the recording medium, and a front or rear surface of the recording medium.

18. The apparatus according to claim 17, wherein the retaining device includes an attracting device arranged to be opposed to the retaining roller and including a charging member configured to attract the recording medium to the retaining roller with static electricity.
